(19) United States
(12) Patent Application Publication
(10) Pub. No.: US 2010/0167145 A1
(43) Pub. Date: Jul. 1, 2010

(54) FUEL CELL SYSTEM AND FUEL CELL SYSTEM CONTROL METHOD

(76) Inventor: Hideaki Kume, Gotemba-shi (JP)

Correspondence Address: KENYON & KENYON LLP, 1500 K STREET N.W., SUITE 700, WASHINGTON, DC, 20005, US

(21) Appl. No.: 12/595,173

(22) PCT Filed: May 23, 2008
(86) PCT No.: PCT/IB08/01294

§ 371 Date: Oct. 8, 2009

(30) Foreign Application Priority Data
May 25, 2007 (JP) 2007-138806

(51) Int. Cl. H01M 8/04

(52) U.S. Cl. 429/429

(57) ABSTRACT

The hydrogen concentration in an anode gas passage of a fuel cell is obtained. When the fuel cell system is started up, one of a first start-up control and a second start-up control is selected based on the obtained hydrogen concentration in the anode gas passage. In the first start-up control, the power generation of the fuel cell is started after purging the anode gas passage. In the second start-up control, the power generation of the fuel cell is started without purging the anode gas passage.

### BACKGROUND OF THE INVENTION

1. Field of the Invention

The invention relates to a fuel cell system and a fuel cell system control method.

2. Description of the Related Art

Japanese Patent Application Publication No. 2005-353569 (JP-A-2005-353569) describes a fuel cell system adapted to operate without discharging fuel gas in its normal operation mode (will hereinafter be referred to as “anode-dead-end type fuel cell system”). In anode-dead-end type fuel cell systems, as the system operation continues, impurities including nitrogen and water accumulate in the gas passages in the respective fuel cells.

If the surfaces of the membrane-electrode assemblies of the respective fuel cells are covered with such impurities, it interferes with the electromotive reactions at the catalytic portions of the electrodes of the respective fuel cells, leading to a decrease in the voltage. Furthermore, such interferences to the electromotive reactions produce abnormal electric potentials, which may degrade the membrane-electrode assemblies. Therefore, in conventional anode-dead-end type fuel cell systems, a gas-discharge valve is timely opened to discharge the impurities accumulating in the anode gas passages to the outside of the fuel cell system from the downstream end of the anode.

Further, when the fuel cell system is being started up, if an excessive amount of impurities exist in the gas passages, it may interfere with the power generation of the fuel cell system and may degrade some portions of the fuel cell system. In the conventional fuel cell systems, therefore, impurities in the anode gas passages are removed by purging the anode gas passages by opening the exhaust valve before starting fuel cell power generation.

Meanwhile, in some cases, the fuel gas left in the anode gas passages when the fuel cell system was shut down the last time remains in the anode gas passages until the next time the fuel cell system is started up. The amount of such residual gas depends on the operation state of the fuel cell system at the time it was shut down the last time, the state of the fuel cell system during the operation suspension, and so on, and therefore the amount of residual gas may be different each time the fuel cell system is stared up. In particular, in anode-dead-end type fuel cell systems, the distribution of fuel gas concentration in the anode gas passages varies depending upon various factors including the flow rate of fuel gas supplied to the fuel cells. Therefore, the amount of fuel gas that is left in the anode gas passages when the fuel cell system is shut down depends on the rate (flow rate) at which fuel gas was being supplied to the fuel cells immediately before the shutting-down of the fuel cell system.

If the anode gas passages are purged when impurities and fuel gas exist in the anode gas passages, the fuel gas is inevitably discharged to the outside of the fuel cell system together with the impurities. Thus, if the anode gas passages are purged when a relatively large amount of fuel gas is left in the anode gas passages, the amount of fuel gas discharged unnecessarily without being used for power generation increases accordingly. However, in view of improving the fuel economy, such waste of fuel gas should, be avoided as much as possible.

### SUMMARY-OF THE INVENTION

The invention relates to a fuel cell system that starts fuel cell power generation while minimizing the amount of fuel gas discharged inevitably and also relates to a method for, controlling such a fuel cell system.

The first aspect of the invention relates to a fuel cell system having: a fuel cell having an anode and a cathode and operable to generate power using fuel gas supplied to the anode and air supplied to the cathode; a gas-discharge mechanism provided downstream of a gas passage in the anode of the fuel cell and operable to purge the gas passage in the anode in response to a purge request; concentration obtaining means for obtaining a concentration of fuel gas in the gas passage in the anode; comparing means for, after a request for starting power generation of the fuel cell has been issued, comparing the fuel gas concentration obtained by the concentration obtaining means with a reference value; and controlling means for, after the request for starting power generation of the fuel cell has been issued, selecting one of a first start-up control and a second start-up control based on the result of the comparison by the comparing means and executing the selected start-up control, the first start-up control being such that power generation of the fuel cell is started after purging the gas passage in the anode and the second start-up control being such that power generation of the fuel cell is started without purging the gas passage in the anode.

According to the fuel cell system described above, during the start-up of the fuel cell system, the fuel gas concentration in the gas passage in the anode is compared with the reference value to determine whether the amount of fuel gas in the same gas passage is enough to start fuel cell power generation. Then, based on the result of this determination, the start-up mode is switched between the mode in which the gas passage in the anode is purged before starting fuel cell power generation and the mode in which fuel cell power generation is started without purging the gas passage in the anode. According to this method, because the purging is performed only when it has been determined that the fuel gas concentration is not enough to start fuel cell power generation, fuel gas is not discharged unnecessarily in a state where fuel cell power generation can be started without performing the purging. As such, fuel cell power generation can be started while minimizing the amount of fuel gas discharged inevitably.

The above-described fuel cell system may further have fuel supplying means for supplying fuel gas to the gas passage in the anode during power generation of the fuel cell and may be such that: the gas-discharge mechanism is capable of variably adjusting a gas discharge rate and adapted to operate, when needed, in a gas-discharge mode in which gas is discharged to the outside of the fuel cell system at a low rate as compared to the rate at which fuel gas is consumed in the gas passage in the anode; and in the second start-up control, the controlling means places the gas-discharge mechanism in the gas-discharge mode after power generation of the fuel cell has been started without purging the gas passage in the anode.

According to the structure described above, during the start-up of the fuel cell system, the start-up mode is switched between the mode in which the gas passage in the anode is purged before starting fuel cell power generation and the mode in which fuel cell power generation is started without performing the purging and thereafter gas in the gas in the anode starts to be discharged in the gas-discharge mode. As such, in a state where residual impurities exist in the gas passage in the anode at the time of starting up the fuel cell system, the method and timing for discharging the impurities are properly selected in accordance with the fuel gas concentration in the gas passage in the anode. As such, the fuel cell system can be started up while minimizing the amount of fuel gas inevitably discharged.

Further, the above-described fuel cell system may be such that in the second start-up control, the controlling means executes, after placing the gas-discharge mechanism in the gas discharge mode, a higher-rate gas discharge control in which the gas-discharge mechanism is operated for a predetermined time at a gas discharge rate higher than a normal gas discharge rate for the gas-discharge mode.

According to the above-described structure, shortage of fuel gas can be more reliably prevented during the start-up of the fuel cell system. For the purpose of minimizing the amount of hydrogen inevitably discharged, the normal gas discharge rate for the gas-discharge mode is low as compared to the rate at which fuel gas is consumed for power generation at the fuel cell. On the other hand, if power generation of the fuel cell is started with residual impurities left in the gas passage in the anode, the impurity concentration then increases at the downstream side of the gas passage. To prevent this, in a state where the amount of such residual impurities tends to be large, the gas discharge rate is increased to discharge the impurities quickly. As such, the fuel cell system can be started up while minimizing the amount of hydrogen inevitably discharged and ensuring quick discharge of the impurities.

Further, the above-described fuel cell system may further have setting means for setting the gas discharge rate of the gas-discharge mechanism for the higher-rate gas-discharge control based on the fuel gas concentration obtained by the concentration obtaining means.

According to the structure described above, when the gas discharge rate needs to be increased after the start of fuel cell power generation to discharge impurities quickly, the gas discharge rate can be accurately increased to an amount corresponding to the fuel gas concentration in the gas passage in the anode.

The second aspect of the invention relates to a fuel cell control method including: obtaining the concentration of fuel gas in a gas passage in an anode of a fuel cell; determining whether the obtained fuel gas concentration is lower than a reference value; starting, if the obtained fuel gas concentration is lower than the reference value, power generation of the fuel cell after purging the gas passage in the anode; and starting, if the obtained fuel gas concentration is not lower than the reference value, power generation of the fuel cell without purging the gas passage in the anode.

### BRIEF DESCRIPTION OF THE DRAWINGS

The foregoing and further objects, features and advantages of the invention will become apparent from the following description of embodiments with reference to the accompanying drawings, wherein like numerals are used to represent like elements and wherein:

FIG. 1 is a view schematically showing the configuration of a fuel cell system according to the first example embodiment of the invention;

FIG. 2 is a view schematically showing the internal structure of each fuel cell and illustrating what occurs in the fuel cell during the operation of the fuel cell system;

FIG. 3 is a graph representing the relation between the hydrogen concentration distribution in the anode gas passage and, the output current of the fuel cell unit;

FIG. 4A and FIG. 4B are graphs illustrating the start-up operation of the fuel cell system of the first example embodiment;

FIG. 5 is a graph representing calculation results indicating the hydrogen concentration distribution in the anode gas passage at the start of fuel cell power generation; and

FIG. 6 is a flowchart representing a control routine executed in the fuel cell system of the first example embodiment.

### DETAILED DESCRIPTION OF THE EMBODIMENTS

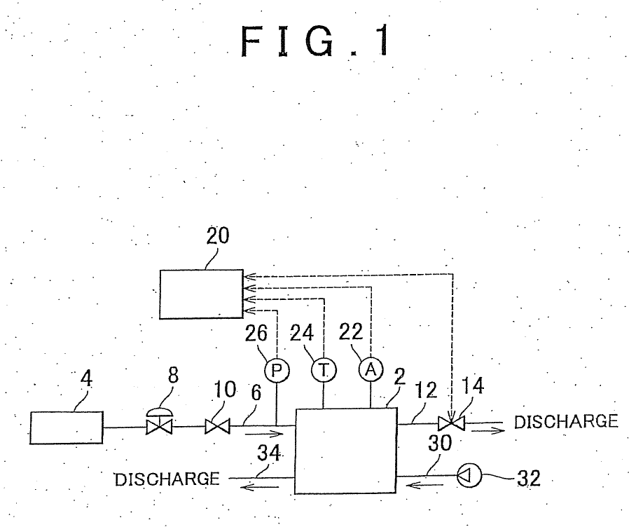

FIG. 1 schematically shows the configuration of a fuel cell system according to the first example embodiment of the invention. This fuel cell system generates power at a fuel cell unit 2 and supplies the generated power to various loads (e.g., motors). The fuel cell unit 2 is a fuel-cell stack constituted of a plurality of fuel cells stacked on top of each other. Each fuel cell is constituted of a pair of power collector plates and a membrane-electrode assembly interposed between the power collector plates, none of which is shown in the drawings. The membrane-electrode assembly is constituted of a solid polymer electrolyte membrane, catalytic portions integrally provided on the both sides of the solid polymer electrolyte membrane, and gas diffusion layers integrally provided on the outer sides of the respective catalytic portions. Each power collector plate serves also as a separator partitioning between two adjacent membrane-electrode assemblies. Each fuel cell generates power using the hydrogen (fuel gas) supplied to the anode and the air supplied to the cathode.

A hydrogen supply pipe 6 is connected to the fuel cell unit 2 so that hydrogen is supplied to the fuel cell unit 2 via the hydrogen supply pipe 6. In the hydrogen supply pipe 6, a hydrogen pressure adjustment valve 8 and a hydrogen inlet valve 10 are provided in this order from the upstream side. Hydrogen is decompressed to a desired pressure at the pressure adjustment valve 8 and then supplied to the fuel cell unit 2. The hydrogen supplied to the fuel cell unit 2 is delivered to the anodes of the respective fuel cells in the fuel cell unit 2 through a supply manifold (not shown in the drawings) formed in the fuel cell unit 2.

The fuel cell system of the first example embodiment has a gas-discharge pipe 12 through which anode gas is discharged from the fuel cell unit 2. The gas-discharge pipe 12 is connected to the downstream ends of the gas passages in the anodes of the respective fuel cells via a gas-discharge manifold (not shown in the drawings) formed in the fuel cell unit 2. In the following description, the gas passages in the anodes of the respective fuel cells of the fuel cell unit 2 will be collectively referred to as “anode gas passage 42”. Thus, the gas in the anode gas passage 42 (anode gas) is collected via the gas-discharge manifold and then discharged to the gas-discharge pipe 12. The downstream end of the gas-discharge pipe 12 is open to the atmosphere or it is connected to a diluter.

An electromagnetically-driven gas-discharge valve 14 is provided in the gas-discharge pipe 12. The gas-discharge valve 14 is a gas-discharge mechanism operated through duty control to switch the communication state of the gas-discharge pipe 12 as needed. Preferably, the gas-discharge valve 14 is of an injector-type because it provides a significant flow rate controllability. That is, because injector-type gas-discharge valves can be opened and closed at a variable rate and they also have a good high frequency response, the use of such a valve provides a high flow rate controllability. Thus, if the gas-discharge valve 14 is an injector-type gas-discharge valve, the gas discharge rate can be accurately controlled as compared to when the gas-discharge valve 14 is a valve only the opening degree of which is variable.

The amount of the anode gas discharged to the outside of the fuel cell system via the anode gas passage 42 can be controlled by controlling the duty ratio of the gas-discharge valve 14. Thus, in the fuel cell system of the first example embodiment, duty control is executed to the gas-discharge valve 14 such that the anode gas is discharged to the outside of the fuel cell system at a very low rate as compared to the rate at which hydrogen is consumed in the anode gas passage 42 (will hereinafter be referred to as “continuous low-rate gas-discharge operation”). In the following, the mode of the duty control for performing this continuous low-rate gas-discharge operation will hereinafter be referred to as “gas-discharge mode”.

When necessary, the gas-discharge valve 14 is, widely opened to purge the anode gas passage 42. At this time, the gas in, the anode gas passage is quickly discharged to the outside of the fuel cell system. Conversely, when necessary, the gas-discharge valve 14 is fully closed, whereby the downstream side of the anode gas passage 42 is closed. As such, the gas-discharge valve 14 is operated in at least three operation modes, “gas-discharge mode”, “purging mode”, and “closed mode”.

An air supply pipe 30 is connected to the fuel cell unit 2 so that air is supplied to the fuel cell unit 2 through the air supply pipe 30. An air pump 32 is provided in the air supply pipe 30. The air pump 32 sends air to the fuel cell unit 2 via the air supply pipe 30. The air supplied to the fuel cell unit 2 is distributed to the cathodes of the respective fuel cells via a supply manifold formed in the fuel cell unit 2. After circulated through each cathode, the air is collected at a gas-discharge manifold fowled in the fuel cell unit 2 and then discharged to a gas-discharge pipe 34.

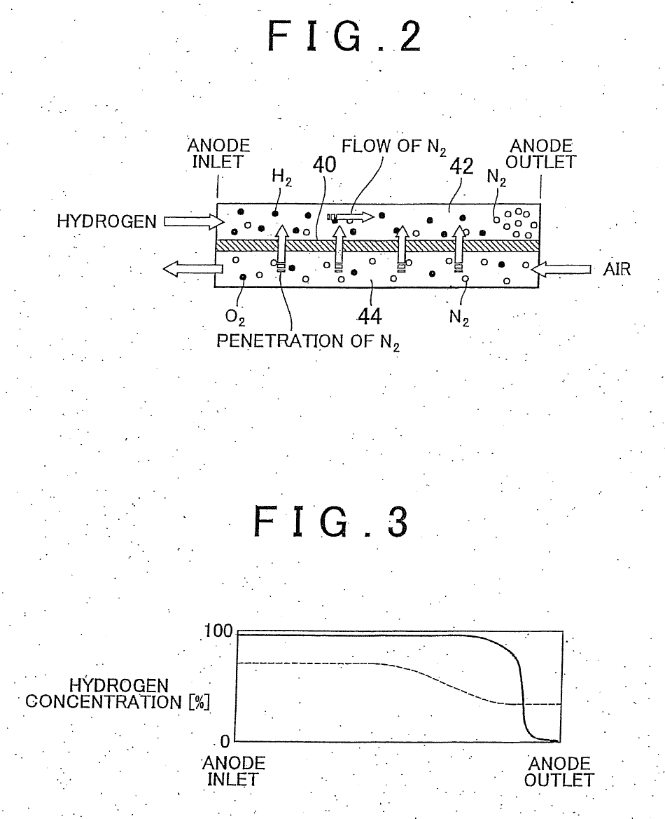

The operation of the gas-discharge valve 14 is controlled by a controller 20. The controller 20 is connected to a pressure sensor 26, a temperature sensor 24, and a current detector 22. The temperature sensor 24 is attached to the fuel cell unit 2 to detect the temperature of the fuel cell unit 2. The current detector 22 is attached to the fuel cell unit 2 to detect the current of the fuel cell unit 2. The pressure sensor 26 detects the pressure in the anode gas passage 42 (FIG. 2).

FIG. 2 schematically shows the internal structure of each fuel cell of the fuel cell unit 2 and illustrates what occurs in the fuel cell during the operation of the fuel cell system. In FIG. 2, only the main portions of the fuel cell are shown and other portions including the respective power collector plates and the respective manifolds are not shown. FIG. 2 will be referred to as needed in the following description together with FIG. 1.

Referring to FIG. 2, gas passages are formed on the respective sides of a membrane-electrode assembly 40 of each fuel cell. One of them is the anode gas passage 42 and the other is a cathode gas passage 44. During the operation of the fuel cell unit, hydrogen is supplied to the anode gas passage 42 and air is supplied to the cathode gas passage 44. Note that the shapes and structures of these gas passages 42, 44 are not specifically limited. For example, grooves may be formed in the surface of the power collector plate (separator) and used as the gas passages 42, 44. Alternatively, porous layers made of a conductive material may be provided between the respective power collector plates and the membrane-electrode assembly 40. In this case, the gas passages 42, 44 are formed by the consecutive pores in the porous layers.

Air, which is supplied to the cathode gas passage 44, contains nitrogen (N₂) as well as oxygen (O₂) used for power generation. Nitrogen is an inactive gas and therefore it is discharged to the outside of the fuel cell system via the cathode gas passage 44 without being used for power generation. However, a portion of such nitrogen penetrates the membrane-electrode assembly 40 and enters the anode gas passage 42 as indicated by the arrows in FIG. 2.

This nitrogen penetration to the anode gas passage 42 side is caused by the difference between the nitrogen partial pressure in the cathode gas passage 44 and that in the anode gas passage 42. The nitrogen (N₂) that has passed through the membrane-electrode assembly 40 is brought to the downstream side of the anode gas passage 42 by the flow of hydrogen (H₂) in the anode gas passage 42 as schematically indicated by the arrows in FIG. 2.

Nitrogen is not used for power generation at the anode either. Therefore, as long as the downstream side of the anode gas passage 42 is closed by the gas-discharge valve 14, the nitrogen in the anode gas passage 42 gradually accumulates at the downstream end of the anode gas passage 42 as schematically illustrated in FIG. 2. If the surfaces of the membrane-electrode assembly 40 are covered with such nitrogen, it interferes with the electromotive reactions at the catalytic portions of the membrane-electrode assembly 40. Such interferences reduce the voltage of the fuel cell and produce abnormal electric potentials, which may degrade the membrane-electrode assembly 40.

In view of this, in the fuel cell system of the first example embodiment, the gas-discharge valve 14 is controlled through duty control so as to discharge the nitrogen in the anode gas passage 42 to the outside of the fuel cell system little by little. Note that in the first example embodiment, the amount of gas to be discharged in the gas-discharge mode is set to a value corresponding to the amount of nitrogen moving to the anode per unit time (will hereinafter be referred to as “cross-leak nitrogen amount”). Thus, a proper amount of nitrogen is discharged while minimizing the amount of hydrogen inevitably discharged.

As well as nitrogen, air contains various other impurities not used for power generation, such as water vapor and carbon oxide. However, the concentrations of such impurities in air are extremely low as compared to that of nitrogen, and therefore only nitrogen is taken into consideration as the impurity in air in this example embodiment. However, this does not mean that impurities other than nitrogen are excluded from the scope of the invention.

FIG. 3 is a graph representing the hydrogen concentration distribution in the anode gas passage 42 during the operation of the fuel cell system of the first example embodiment and illustrating how said distribution varies. Note that the difference of the hydrogen concentration from 100% at each point of the graph represents the nitrogen concentration at the same point. In the graph, the solid curve indicates the hydrogen concentration distribution in the anode gas passage 42 in a state where nitrogen has accumulated at the downstream end of the anode gas passage 42. If the aforementioned continuous low-rate gas-discharge operation is performed in this state, the nitrogen can be preferentially discharged while minimizing the amount of hydrogen discharged.

The nitrogen distribution the anode gas passage 42 depends on the state of the nitrogen flow in the anode gas passage 42. When nitrogen is flowing toward the downstream side in the anode gas passage 42 as schematically indicated by the arrows in FIG. 2, nitrogen inevitably accumulates at the downstream end of the anode gas passage 42.

Meanwhile, the state of the nitrogen flow in the anode gas passage 42 depends on the rate at which nitrogen diffuses in the anode gas passage 42 and the rate at which hydrogen flows in the anode gas passage 42. If the hydrogen flow rate is higher than the nitrogen diffusion rate, the nitrogen that has entered the anode gas passage 42 through the membrane-electrode assembly 40 is brought to the downstream side of the anode gas passage 42 without diffusing to the upstream side. As a result, the hydrogen concentration distribution in the anode gas passage 42 becomes as indicated by the solid curve in FIG. 3.

On the other hand, if the hydrogen flow rate is lower than the nitrogen diffusion rate, the nitrogen diffuses to the upstream side of the anode gas passage 42. As a result, the hydrogen concentration distribution in the anode gas passage 42 becomes as indicated by the dotted curve in FIG. 3. The hydrogen flow rate is continuously adjusted to a value corresponding to the operation load on the fuel cell unit 2 under the control of the controller 20. That is, as the operation load on the fuel cell unit 2 increases, the required output current increases, and therefore the hydrogen flow rate is increased accordingly.

As such, the gas concentration distributions in the anode gas passage 42 vary according to the operation state of the fuel cell system, and as the gas concentration distributions in the anode gas passage 42 vary, the hydrogen concentration in the anode gas passage 42 varies accordingly. Therefore, the gas discharge rate for the gas-discharge mode is preferably determined in consideration of the amount of nitrogen that moves through the membrane-electrode assembly 40 and the hydrogen concentration distribution in the anode gas passage 42. In view of this, for example, the normal gas discharge rate for the gas-discharge mode may be changed in accordance with the output current of the fuel cell unit 2. In this case, further, the pressure in the anode gas passage 42 and the variation of the nitrogen diffusion rate caused by changes in the temperature in the anode gas passage 42 may also be referenced as parameters.

In the fuel cell system of the first example embodiment, the controller 20 stores data of a hydrogen concentration estimation process. This procedure is executed to estimate the amount of fuel gas remaining in the anode as passage 42 based on the time from when the fuel cell system was shut down the last time to when the fuel cell system was started up this time.

As mentioned earlier with reference to FIG. 2, the partial pressure difference between the anode and the cathode, which are opposite each other across the membrane-electrode assembly 40, causes gas movement between the anode and the cathode. If the fuel cell system is shut down after operating for a while in a certain state, hydrogen of an amount corresponding to that operation state is left in the anode gas passage 42. This residual hydrogen moves to the cathode gas passage 44 in time after the shutdown of the fuel cell system.

As a result, the hydrogen concentration in the anode gas passage 42 gradually decreases in time after the shutdown of the fuel cell system. On the other hand, as opposed to such a decrease in the hydrogen concentration in the anode gas passage 42, nitrogen moves from the anode to the cathode due to the difference in the nitrogen partial pressure between the anode and the cathode. In the hydrogen concentration estimation process, the amount of gas that moves from the cathode to the anode per unit time (cross-leak amount) is determined in advance, and the hydrogen concentration in the anode gas passage 42 is estimated in accordance with the time from when the fuel cell system was shut down.

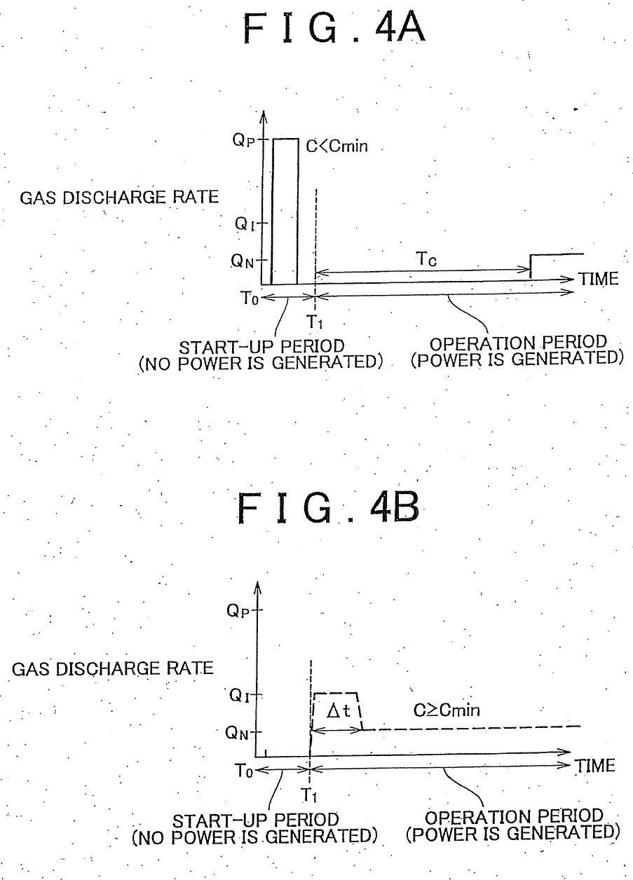

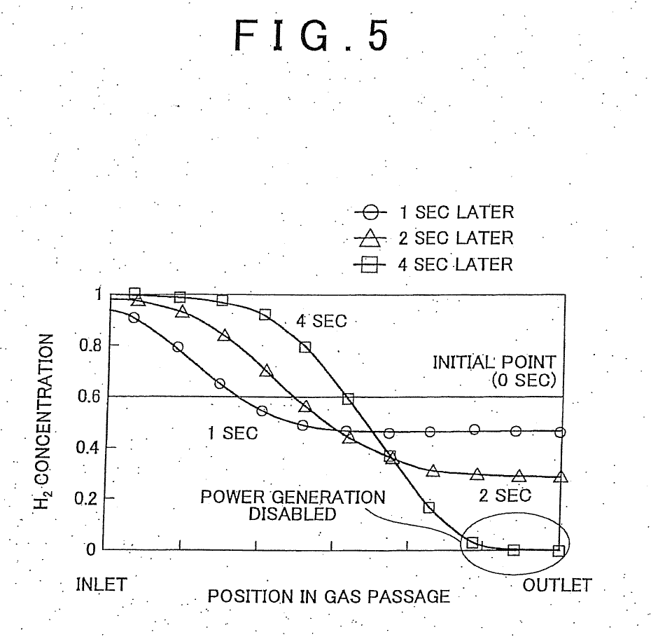

Hereinafter, the operation of the fuel cell system of the first example embodiment will be described with reference to FIG. 4A and FIG. 4B. FIG. 4A and FIG. 4B are graphs illustrating how the gas-discharge valve 14 is controlled in time from the start-up of the fuel cell system to the beginning of the normal power generation at the fuel cell unit 2. In the graphs of FIG. 4A and FIG. 4B, the vertical axis represents the gas discharge rate at the gas-discharge valve 14 and the horizontal axis represents time. In the graphs, T₁ represents the time point at which the power generation of the fuel cell unit 2 starts, and thus the region on the left of the time T₁ represents the time period in which the fuel system is started up and thus no power is generated, and the region on the right of the time T₁ represents the time period in which the fuel cell system generates power at the fuel cell unit 2. In the graphs, Q_{N} represents the gas discharge rate normally set at the gas-discharge valve 14 in the gas-discharge mode.

Further, in the first example embodiment, the minimum hydrogen concentration required for the fuel cell unit 2 to start power generation is empirically determined in advance. More specifically, the minimum hydrogen concentration required to produce a sufficient level of OCV (Open Circuit Voltage) at the start of power generation (will hereinafter be referred to as “lower limit hydrogen concentration Cₘᵢₙ”) is empirically determined in advance. The lower limit hydrogen concentration Cₘᵢₙ is, for example, approx. 10%.

In the first example embodiment, when a request for the fuel cell unit 2 to start power generation is issued after the start-up of the fuel cell system, the controller 20 first executes the hydrogen concentration estimation process, the data of which is stored in the controller 20. In the examples illustrated in FIG. 4A and FIG. 4B, it is assumed for descriptive convenience that the hydrogen concentration estimation process is executed at time T₀. Thus, an estimated value C of the hydrogen concentration in the anode gas passage 42 at time T₀ is obtained.

Subsequently, the estimated hydrogen concentration C obtained at time T₀ is compared with the lower limit hydrogen concentration Cₘᵢₙ. At this time, if the estimated hydrogen concentration C is lower than the lower limit hydrogen concentration Cₘᵢₙ(C<Cₘᵢₙ), it indicates that the fuel cell unit 2 is not yet ready to start power generation. On the other hand, if the estimated hydrogen concentration C is equal to or higher than the lower limit hydrogen concentration Cₘᵢₙ (C≧Cₘᵢₙ), it indicates that the fuel cell unit 2 is ready to start power generation. As such, whether the fuel cell unit 2 is ready to start power generation is determined through comparison between the estimated hydrogen concentration C and the lower limit hydrogen concentration Cₘᵢₙ.

Subsequently, one of a first start-up control and a second start-up control, which will be described later, is selected based on the result of the above comparison between the estimated hydrogen concentration C and the lower limit hydrogen concentration Cₘᵢₙ and the selected start-up control is executed. In the following, the first start-up control will be described with reference to FIG. 4A, and the second start-up control will be described with reference to FIG. 4B.

In the fuel cell system of the first example embodiment, if the estimated hydrogen concentration C is lower than the lower limit hydrogen concentration Cₘᵢₙ, the first start-up control is executed. The graph of FIG. 4A illustrates the operation of the gas-discharge valve 14 under the first start-up control. In the graph of FIG. 4A, the solid lines represent the gas discharge rate at the gas-discharge valve 14. In the first start-up control, the anode gas passage 42 is first purged. At this time, more specifically, the gas-discharge valve 14 is operated to set the gas discharge rate to Q_{P} that is a predetermined rare for quickly discharging a total volume V_{A} of gas in the anode gas passages in the respective fuel cells of the fuel cell unit 2. Through this purging, nitrogen is removed from the anode gas passage 42, whereby a good startability of the fuel cell system is ensured.

After the purging of the anode gas passage 42 has been finished, the gas-discharge valve 14 is closed. Then, a process for starting power generation of the fuel cell unit 2 is executed at time T₁, so that hydrogen starts to be supplied to the fuel cell unit 2 and the fuel cell unit 2 starts generating power at a given level.

Further, in the fuel cell system of the first example embodiment, after the start of power generation of the fuel cell unit 2, the gas-discharge valve 14 is kept closed until a predetermined time T_{C} has passed. The predetermined time T_{C} is time needed for the hydrogen concentration at the downstream end of the anode gas passage 42 to become substantially zero after power generation of the fuel cell unit 2 is started after the purging of the anode gas passage 42. Thus, the gas-discharge valve 14 is kept closed for the predetermined time T_{C} after the start of power generation of the fuel cell unit 2. The predetermined time T_{C} is determined in advance in consideration of the nitrogen penetration amount, the output current density, etc. When the predetermined time T_{C} has passed, the gas-discharge valve 14 is placed in the aforementioned gas-discharge mode, whereby the normal power generation of the fuel cell unit 2 starts.

In the first start-up control, because the purging of the anode gas passage 42 is performed when starting up the fuel cell system as: described above, the anode gas passage 42 can be filled with almost pure hydrogen at the start of the power generation of the fuel cell unit 2. For minimizing the amount of hydrogen inevitably discharged, the gas-discharge valve 14 should not be opened unnecessarily when the hydrogen concentration in the anode gas passage 42 is high. In view of this, according to the first start-up control in the first example embodiment, power generation is performed with the gas-discharge valve 14 closed until the amount of nitrogen in the anode gas passage 42 increases to a level requiring the nitrogen discharge.

For example, the predetermined time T_{C} can be determined in the following manner. First, the amount of nitrogen that leaks to the anode gas passage 42 (nitrogen cross-leak amount) under the operation state at the start of power generation is empirically determined and a map for determining the nitrogen amount in the anode gas passage 42 in accordance with the elapsed time is formulated based on the determined nitrogen cross-leak amount. By referring to this map, it is possible to estimate the amount of nitrogen at the downstream side of the anode gas passage 42 at a particular time point after the start of power generation. Further, the hydrogen flow rate at this time can also be determined if the output current density at the start of power generation is constant. Further, the amount of hydrogen consumed for power generation can, be determined from the output at the start-up of the fuel cell system. Using such information, how the hydrogen concentration distribution changes in time after the start of power generation can be predicted, and based on the result of this prediction, the time needed for the hydrogen concentration at the downstream end of the anode gas passage 42 to become substantially zero after the start of power generation can be estimated.

If the output current density changes after the start of power generation, the nitrogen cross-leak amount changes. Further, the nitrogen cross-leak amount also changes depending upon the property of the electrolyte membrane of the membrane-electrode assembly 40. Thus, preferably, the aforementioned map for estimating the nitrogen amount is changed or corrected in accordance with the output current density at the start of power generation and the property of the electrolyte membrane of the membrane-electrode assembly 40. Further, as well as or instead of the aforementioned map, a model for estimating the amount of nitrogen in the anode gas passage 42 may be prepared and used. As such, the time from the start of power generation to when the output (voltage) of the fuel cell system starts decreasing may be empirically determined in more simple manners.

Meanwhile, in the fuel cell system of the first example embodiment, the second start-up control illustrated in FIG. 4B is executed if the estimated hydrogen concentration C is equal to or higher than the lower limit hydrogen concentration Cₘᵢₙ. In the graph of FIG. 4B, the dotted lines represent how the gas discharge rate at the gas-discharge valve 14 is changed in time in the second start-up control. As mentioned earlier, if the estimated hydrogen concentration C is equal to or higher than the lower limit hydrogen concentration Cₘᵢₙ, it indicates that the hydrogen concentration in the anode gas passage 42 is equal to or higher than the minimum concentration required to start power generation. Therefore, in the second start-up control, the power generation of the fuel cell unit 2 is started without purging the anode gas passage 42 in advance unlike in the first start-up control. As such, the hydrogen in the anode gas passage 42 is used for power generation.

Because the purging of the anode gas passage 42 is not performed in the second start-up control unlike in the first start-up control, the residual nitrogen still exists in the anode gas passage 42 when fuel cell system is started up. The graph of FIG. 5 represents calculation results indicating how the hydrogen concentration distribution changes in time after power generation is started while the residual nitrogen is left in the anode gas passage 42. In the graph of FIG. 5, the horizontal axis represents the position in the anode gas passage 42 while the vertical axis represents a relative value of the hydrogen concentration. The formats of FIG. 5 and FIG. 3 both indicating the hydrogen concentration are the same as each other.

In FIG. 5, the initial point (0 second) of the graph of FIG. 5 indicates the hydrogen concentration distribution in a state where the fuel cell unit 2 is not performing power generation. FIG. 5 indicates the hydrogen concentration distributions obtained 1, 2, and 4 seconds after the start of power generation. At the initial point (0 second), no hydrogen is supplied to the fuel cell unit 2 and therefore nitrogen uniformly spreads throughout the anode gas passage 42. In this state, therefore, the hydrogen gas concentration is uniform throughout the anode gas passage 42 (0.6 in the example of FIG. 5). If hydrogen starts to be supplied to start the power generation in this state; the flow of hydrogen brings the nitrogen toward the downstream side of the anode gas passage 42.

Thus, as the time passes by 1 second, 2, seconds, 4 seconds, and so on, the nitrogen concentration at the downstream side of the anode gas passage 42 increases and therefore the hydrogen concentration at the downstream side of the anode gas passage 42 decreases accordingly. Further, during this time, as hydrogen is consumed for the power generation of the fuel cell unit 2, the reduction of the hydrogen concentration at the downstream side of the anode gas passage 42 is accelerated. As a result, according to the calculation results shown in FIG. 5, the hydrogen concentration at the downstream side of the anode gas passage 42 becomes zero 4 seconds after the start of the power generation. Thus, power generation can not be continued any more at this portion of the anode gas passage 42.

In view of the above, in the second start-up control, the gas discharge rate at the gas-discharge valve 14 is made higher than the normal gas discharge rate Q_{N} for the gas-discharge mode for a predetermined time Δt after the start of power generation, and when the predetermined time Δt has passed, the gas discharge rate at the gas-discharge valve 14 is set to the normal gas discharge rate Q_{N}. In FIG. 4A and FIG. 4B, the above gas discharge rate higher than the normal gas discharge rate Q_{N} is denoted Q₁. As such, by increasing the gas discharge rate at the gas-discharge valve 14 in the initial period after the start of power generation, a proper use of hydrogen for power generation and quick nitrogen discharge at the start-up of the fuel cell system can be achieved.

According to the fuel cell system of the first example embodiment, as described above, the concentration of the residual hydrogen is estimated when starting up the fuel cell system, and it is then determined based on the estimated residual hydrogen concentration whether to purge the anode gas passage 42 before starting the power generation of the fuel cell unit 2. Then, based the result of this determination, one of the first start-up control, in which purging is performed before power generation is started, and the second start-up control, in which power generation is started without purging, is selected. As such, it is possible to start power generation of the fuel cell unit 2 while minimizing the amount of hydrogen inevitably discharged.

According to the fuel cell system of the first example embodiment, further, the continuous low-rate gas-discharge operation is executed in the gas-discharge mode after the power generation is started in the second start-up control in which the purging of the anode gas passage 42 is not performed. That is, according to the above-described control procedure, if the fuel cell unit 2 is not ready to start power generation, the anode gas passage 42 is purged, and if the fuel cell system is ready to start power generation, the second start-up control is executed so that power generation is performed in the continuous low-rate gas-discharge mode, whereby nitrogen is discharged to the outside of the fuel cell system while minimizing the amount of hydrogen inevitably discharged. As such, the method for removing residual nitrogen is switched between the two methods as the situation demands, whereby the fuel cell system can be started up while minimizing the waste of hydrogen.

According to the fuel cell system of the first example embodiment, further, the gas-discharge valve 14 is operated at the gas discharge rate Q₁ after the start of power generation. In this manner, even if a large amount of residual nitrogen exists in the anode gas passage 42 when the fuel cell system is started up, the residual nitrogen can be quickly discharged to the outside of the fuel cell system, and thus a good power generation state can be achieved in an early stage. As such, the amount of hydrogen inevitably discharged is minimized, and the residual nitrogen is quickly discharged to the outside of the fuel cell system during the power generation. Note that the gas discharge rate Q₁ may be set independent of the normal gas discharge rate Q_{N}.

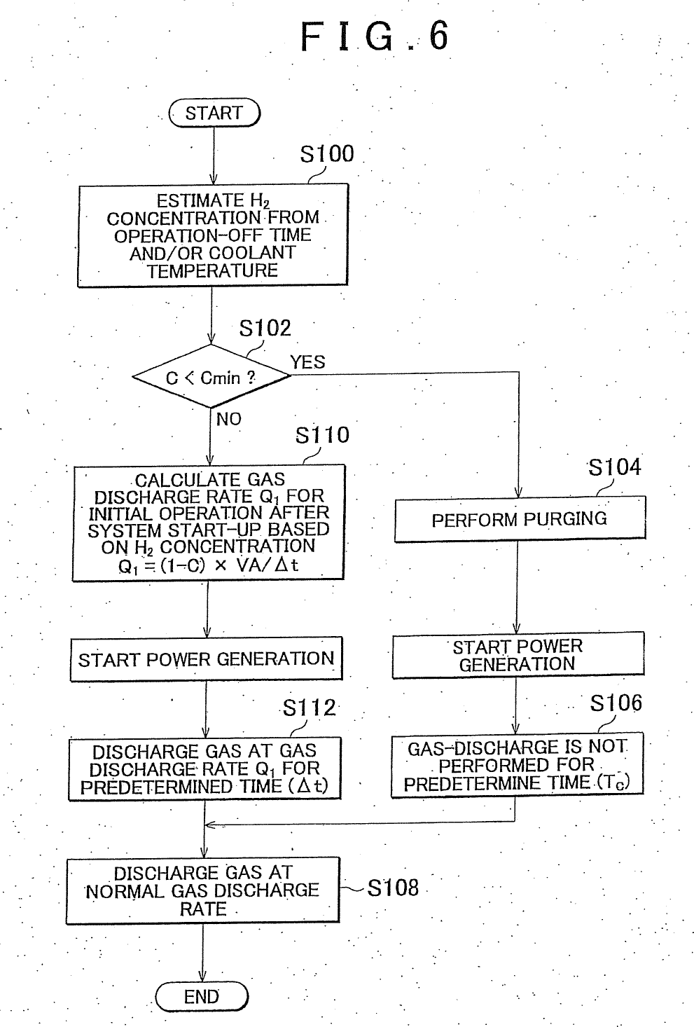

Hereinafter, a control routine executed in the fuel cell system of the first example embodiment will be described in detail with reference to FIG. 6. The flowchart of FIG. 6 represents the control routine executed in the fuel cell system of the first example embodiment. This control routine is executed after a request for starting up the fuel cell system has been issued. Thus, the gas-discharge valve 14 is in a closed state when the control routine is started. In a case where the fuel cell system is used in a vehicle, whether the fuel cell system is presently requested to be started up is determined based on whether the ignition has been turned on.

In the control routine of FIG. 6, the hydrogen concentration C in the anode gas passage 42 is first estimated (step S100). More specifically, in this step, the controller 20 estimates the present hydrogen concentration C by executing the hydrogen concentration estimation process.

Then, it is determined whether the estimated hydrogen concentration C is lower than the lower limit hydrogen concentration Cₘᵢₙ (step S102). More specifically, in this step, the controller 20 compares the estimated hydrogen concentration C with the lower limit hydrogen concentration Cₘᵢₙ and determines whether the estimated hydrogen concentration C is lower than the lower limit hydrogen concentration Cₘᵢₙ. If it is determined in this step that the estimated hydrogen concentration C is lower than the lower limit hydrogen concentration Cₘᵢₙ (C<Cₘᵢₙ), it is determined that the fuel cell unit 2 is not ready to start power generation. In this case, therefore, the anode gas passage 42 is purged (step S104), so that the gas in the anode gas passage 42 is quickly discharged to the outside of the fuel cell system. After step S104, the power generation of the fuel cell unit 2 is started.

Subsequently, the controller 20 keeps the gas-discharge valve 14 closed for the predetermined time Tc after the start of the power generation of the fuel cell unit 2 (step S106). The length of the time T_{C} may be determined using the above-described map indicating the nitrogen amount in the anode gas passage 42 corresponding to the elapsed time. For example, the predetermined time T_{C} is set within the range of several tens of minutes to several hours. Note that the length of the predetermined time T_{C} is not limited to this range. After the time T_{C} has passed, the gas discharge rate at the gas-discharge valve 14 is set to the normal gas discharge rate Q_{N}, after which the present cycle of the control routine is finished.

On the other hand, it is determined in step S102 that the estimated hydrogen concentration C is equal to or higher than the lower limit hydrogen concentration Cₘᵢₙ (C≧Cₘᵢₙ), it is determined that the fuel cell unit 2 is ready to start power generation. In this case, first, the gas discharge rate Q₁ that will be used in the initial stage after the start-up of the fuel cell system is calculated in accordance with the estimated hydrogen concentration C (step S110). More specifically, in this step, the controller 20 calculates the gas discharge rate Q₁ using the equation (1) indicated below.

Q₁=(1−C)×V_{A}/Δt (1)

In the equation (1), “C” represents the estimated hydrogen concentration, and “V_{A}” represents the total capacity of the anode gas passages in the respective fuel cells of the fuel cell unit 2. According to the equation (1), the value of 0 to 1.0 is substituted into C in accordance with the hydrogen concentration of 0 to 100%. For example, 0.5 is substituted into C when the estimated hydrogen concentration is 50%, and 0.1 is substituted into C when the estimated hydrogen concentration is 10%. Therefore, in the equation (1), (1−C)×V_{A} represents the total amount of substances other than hydrogen in the anode gas passages (total impurity amount). “Δt” represents the time for which as is discharged at the increased rate immediately after the start-up of the fuel cell system. This time is set to, for example, approx. 5 sec. Thus, according to the equation (1), the gas discharge rate Q₁ is obtained by dividing the total amount of impurities needed to be discharged to the outside of the fuel cell system after the start-up of the fuel cell system by a given time.

After the gas discharge rate Q₁ has been set in step S110, the power generation of the fuel cell unit 2 is started with the gas-discharge valve 14 closed. As such, the hydrogen remaining in the anode gas passage 42 at the start-up of the fuel cell system can be consumed for the power generation of the fuel cell unit 2.

Subsequently, the gas-discharge valve 14 is operated at the gas discharge rate Q₁ for the time Δt after the start of power generation (step S112). As the power generation of the fuel cell unit 2 starts, hydrogen starts to be supplied to the fuel cell unit 2, and then nitrogen concentrates on the downstream side of the anode gas passage 42 as described above with reference to FIG. 3. According to the process in step S112, however, the nitrogen can be quickly, and preferentially, discharged to the outside of the fuel cell system. Then, when the time Δt has passed, the gas discharge rate is set to the normal gas discharge rate Q_{N}, after which the present cycle of the control routine is finished.

According to the control routine described above, the fuel cell system can be started up while minimizing the wasteful discharge of hydrogen.

In the first example embodiment described above, the gas-discharge valve 14 may be regarded as one example of “gas-discharging means” cited in the claims, and the hydrogen concentration estimation process may be regarded as one example of “concentration obtaining means” cited in the claims. Further, the process of step S102 of the control routine of the first example embodiment may be regarded as one example of “comparing means” and as one example of “controlling means” cited in the claims. Further the processes of step S104 and its subsequent steps may be collectively regarded as one example of “first start-up control” cited in the claims, and the processes of step S110 and its subsequent steps may be collectively regarded as one example of “second start-up control” cited in the claims.

Further, the process of step S112 may be regarded as one example of “higher-rate gas discharge control” cited in the claims, the time Δt may be regarded as one example of “predetermined time” cited in the claims, and the process of step S110 may be regarded as one example of “setting means” cited in the claims.

According to the fuel cell system of the first example embodiment, as described above, the gas-discharge valve 14 is operated at the gas discharge rate Q₁ (Q₁>Q_{N}) for the predetermined time Δt after the start of the power generation of the fuel cell unit 2. However, the gas-discharge valve 14 may alternatively be operated at the normal gas discharge rate Q_{N} after the start of the power generation of the gas-discharge valve 14. That is, step S110 and S112 may be omitted from the control routine shown in FIG. 6.

Further, information regarding the hydrogen concentration may be obtained in various other methods than that used in the foregoing hydrogen concentration estimation process. For example, the variation of the nitrogen concentration in the anode gas passage 42 has a correlation with the variation of the temperature of the coolant for cooling the fuel cell unit 2. Thus, the nitrogen concentration in the anode gas passage 42 can be estimated based on the variation of the temperature of the coolant, and the hydrogen concentration in the anode gas passage 42 can be calculated from the estimated nitrogen concentration.

Further, a hydrogen concentration sensor may be provided in the fuel cell unit 2 so as to be in communication with the anode gas passage 42, and the hydrogen concentration in the anode gas passage 42 may be determined from the value detected by the hydrogen concentration sensor. Further, various techniques known in the art may be used to obtain information regarding the hydrogen concentration in the anode gas passage 42 as well as those describe above. In the case where a hydrogen concentration sensor is used to obtain the hydrogen concentration in the anode gas passage 42, the hydrogen concentration sensor may be regarded as one example of “concentration obtaining means” cited in the claims.

In the fuel cell system of the first example embodiment, the gas-discharge valve 14 is kept closed for the time T_{C} after the start of the power generation of the fuel cell unit 2 (step S106 of the control routine in FIG. 6). However, the gas-discharge valve 14 may alternatively be placed in the gas-discharge mode immediately after the start of the power generation without being kept closed for a white.

Further, in the fuel cell system of the first example embodiment, as described above, the continuous low-rate gas-discharge operation is performed after the start of the power generation of the fuel cell unit 2. However, the fuel cell system may alternatively be such that the anode gas passage 42 is intermittently purged during the power generation of the fuel cell unit 2. In this case, step S110 and step S112 are omitted from the control routine of FIG. 6, and the process in step S108 is modified to a process for starting the normal gas-discharge control (the operation mode in which the power generation of the fuel cell unit 2 is performed while purging the anode gas passage 42 intermittently).

According to this modification, even in fuel cell systems in which the foregoing continuous low-rate gas-discharge operation is not performed, when the fuel cell system is being started up, the start-up mode can be properly switched between the mode in which the anode gas passages are purged before the start of power generation and the mode in which said purging is not performed, based on the amount fuel gas remaining in the anode gas passages, as in the fuel cell system of the first example embodiment.

While the invention has been described with reference to what are considered to be preferred embodiments thereof, it is to be understood that the invention is not limited to the disclosed embodiments or constructions. On the contrary, the invention is intended to cover various modifications and equivalent arrangements. In addition, while the various elements of the disclosed invention are shown in various combinations and configurations, which are exemplary, other combinations and configurations, including more, less or only a single element, are also within scope of the invention.

1. A fuel cell system, comprising:
a fuel cell having an anode and a cathode and operable to generate power using fuel gas supplied to the anode and air supplied to the cathode;
a gas-discharge mechanism provided downstream of a gas passage in the anode of the fuel cell and operable to purge the gas passage in the anode in response to a purge request;
a concentration obtaining portion that obtains a concentration of fuel gas in the gas passage in the anode;
a comparing portion that, after a request for starting power generation of the fuel cell has been issued, compares the fuel gas concentration obtained by the concentration obtaining portion with a reference value; and
a control portion that, after the request for starting power generation of the fuel cell has been issued, selects one of a first start-up control and a second start-up control based on the result of the comparison by the comparing portion and then executes the selected start-up control, the first start-up control being such that power generation of the fuel cell is started after purging the gas passage in the anode and the second start-up control being such that power generation of the fuel cell is started without purging the gas passage in the anode.

2. The fuel cell system according to claim 1, further comprising a fuel supplying portion that supplies fuel gas to the gas passage in the anode during power generation of the fuel cell, wherein
the gas-discharge mechanism is capable of variably adjusting a gas discharge rate and adapted to operate, when needed, in a gas-discharge mode in which gas is discharged to the outside of the fuel cell system at a low rate as compared to the rate at which fuel gas is consumed in the gas passage in the anode, and
in the second start-up control, the control portion places the gas-discharge mechanism in the gas-discharge mode after power generation of the fuel cell has been started without purging the gas passage in the anode.

3. The fuel cell system according to claim 2, wherein
in the second start-up control, the control portion executes, after placing the gas-discharge mechanism in the gas discharge mode, a higher-rate gas discharge control in which the gas-discharge mechanism is operated for a predetermined time at a gas discharge rate higher than a normal gas discharge rate for the gas-discharge mode.

4. The fuel cell system according to claim 3, further comprising a setting portion that sets the gas discharge rate of the gas-discharge mechanism for the higher-rate gas-discharge control based on the fuel gas concentration obtained by the concentration obtaining portion.

5. The fuel cell system according to claim 1, wherein
in the first start-up control, the control portion suspends discharging of gas from the gas passage in the anode via the gas-discharge mechanism for a predetermined time after power generation of the fuel cell has been started, and after the predetermined time has passed, the control portion controls the gas-discharge mechanism such that gas is continuously discharged from the gas passage in the anode to the outside of the fuel cell system at a low rate as compared to the rate at which fuel gas is consumed in the gas passage in the anode.

6. The fuel cell system according to claim 1, wherein
the concentration obtaining portion obtains the fuel gas concentration in the gas passage in the anode by estimating the fuel gas concentration based on the time from when the fuel cell system was shut down.

7. The fuel cell system according to claim 1, wherein
the concentration obtaining portion obtains the fuel gas concentration in the gas passage in the anode by estimating the fuel gas concentration based on the temperature of coolant for cooling the fuel cell.

8. The fuel cell system according to claim 1, further comprising a sensor for detecting the fuel gas concentration in the gas passage in the anode, wherein
the concentration obtaining portion obtains the fuel gas concentration detected by the sensor.

9. The fuel cell system according to claim 3, further comprising a current detector for detecting an output current of the fuel cell, wherein
the control portion changes the normal gas discharge rate based on the output current detected by the current detector.

10. The fuel cell system according to claim 1, wherein
in the second start-up control, the control portion controls the gas-discharge mechanism to purge the gas passage in the anode intermittently after power generation of the fuel cell has been started without purging the gas passage.

11. The fuel cell system according to claim 1, wherein
in the first start-up control, the control portion suspends discharging of gas from the gas passage in the anode via the gas-discharge mechanism for a predetermined time after power generation of the fuel cell has been started, and after the predetermined time has passed, the control portion controls the gas-discharge mechanism to purge the gas passage in the anode intermittently.

12. The fuel cell system according to claim 5, wherein
the control portion estimates the amount of nitrogen in the gas passage in the anode after the start of power generation of the fuel cell and sets the predetermined time based on the estimated nitrogen amount.

13. The fuel cell system according to claim 1, wherein
the control portion executes the purging of the gas passage in the anode if the fuel gas concentration obtained by the concentration obtaining portion is lower than the reference value, and the control portion does not execute the purging of the gas passage in the anode if the fuel gas concentration obtained by the concentration obtaining portion is equal to or higher than the reference value.

14. A fuel cell control method, comprising:
obtaining a concentration of fuel gas in a gas passage in an anode of a fuel cell;
determining whether the obtained fuel gas concentration is lower than a reference value;
starting, if the obtained fuel gas concentration is lower than the reference value, power generation of the fuel cell after purging the gas passage in the anode; and
starting, if the obtained fuel gas concentration is not lower than the reference value, power generation of the fuel cell without purging the gas passage in the anode.

15. (canceled)

16. The fuel cell system according to claim 11, wherein
the control portion estimates the amount of nitrogen in the gas passage in the anode after the start of power generation of the fuel cell and sets the predetermined time based on the estimated nitrogen amount.
